(19) United States
(12) Patent Application Publication
(10) Pub. No.: US 2017/0302910 A1
(43) Pub. Date: Oct. 19, 2017

(54) METHOD AND APPARATUS FOR MERGING DEPTH MAPS IN A DEPTH CAMERA SYSTEM

(71) Applicant: Motorola Mobility LLC, Chicago, IL (US)

(72) Inventor: By-Her W. Richards, Lincolnshire, IL (US)

(21) Appl. No.: 15/133,092

(22) Filed: Apr. 19, 2016

(51) Int. Cl. H04N 13/02

(52) U.S. Cl. CPC H04N 13/0271; H04N 13/0239; G06T 2207/20221; G06T 2207/10012

(57) ABSTRACT

A method and apparatus merge depth maps in a depth camera system. According to a possible embodiment, a first image of a scene can be received. The first image can include first image coordinates. A second image of the scene can be received. A third image of the scene can be received. An x-axis depth map of the first image coordinates can be generated based on the first and second images. A y-axis depth map of the first image coordinates can be generated based on the first and third images. The y-axis can be perpendicular to the x-axis. Edge detection can be performed on the first image to detect edges in the first image. A confidence score map can be generated for each depth map. A higher confidence score on the confidence score map of the x-axis depth map can be set for a pixel on an edge at an angle closer to the y-axis than the x-axis for the pixel on the x-axis depth map. A lower confidence score on the confidence score map of the y-axis depth map can be set for a corresponding pixel on the y-axis depth map. A depth value of a pixel on a fusion depth map can be selected based on the confidence score maps and the depth maps.

### BACKGROUND

### 1. Field

The present disclosure is directed to a method and apparatus for merging depth maps in a depth camera system. More particularly, the present disclosure is directed to merging depth maps in a depth camera system with horizontal and vertical parallax.

2. Introduction

Presently, people enjoy taking pictures of friends, family, children, vacations, flowers, landscapes, and other scenes using digital cameras that have sensors. Devices that have digital cameras include cellular phones, smartphones, tablet computers, compact cameras, DSLR cameras, personal computers, and other devices that have digital cameras. Some devices have two cameras that are used to generate three-dimensional (3D) images. A 3D image is generated from the two cameras using a depth map that is based on parallax, which is the displacement or difference in the apparent position of an object viewed along two different lines of sight. Unfortunately, the resulting images still suffer from inaccuracy because they only use one depth map from two cameras.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an example block diagram of a system according to a possible embodiment;

FIG. 2 is an example illustration of parallax of an object according to a possible embodiment;

FIG. 3 is an example illustration of a triangulation relationship according to a possible embodiment;

FIG. 4 is an example illustration of a device including three cameras according to a possible embodiment;

FIG. 5 is an example illustration of a device including four cameras according to a possible embodiment;

FIG. 6 is an example flowchart illustrating the operation of a device according to a possible embodiment; and

FIG. 7 is an example block diagram of an apparatus according to a possible embodiment.

### DETAILED DESCRIPTION

Embodiments provide a method and apparatus for merging depth maps in a depth camera system. According to a possible embodiment, a first image of a scene can be received. The first image can include first image coordinates. A second image of the scene can be received. A third image of the scene can be received. An x-axis depth map of the first image coordinates can be generated based on the first and second images. A y-axis depth map of the first image coordinates can be generated based on the first and third images. The y-axis can be perpendicular to the x-axis. Edge detection can be performed on the first image to detect edges in the first image. A confidence score map can be generated for each depth map. A higher confidence score on the confidence score map of the x-axis depth map can be set for a pixel on an edge at an angle closer to the y-axis than the x-axis for the pixel on the x-axis depth map. A lower confidence score on the confidence score map of the y-axis depth map can be set for a corresponding pixel on the y-axis depth map. A depth value of a pixel on a fusion depth map can be selected based on the confidence score maps and the depth maps.

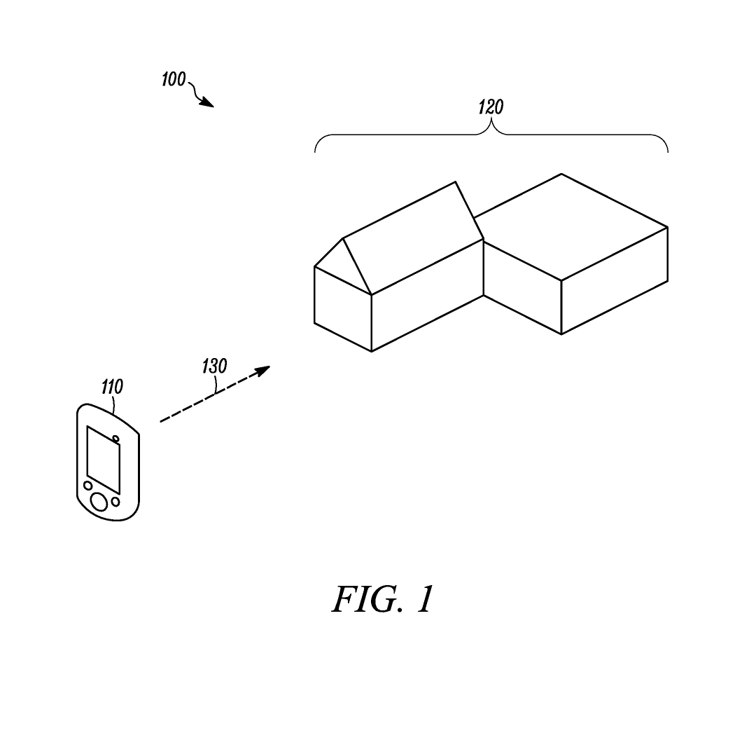

FIG. 1 is an example block diagram of a system 100 according to a possible embodiment. The system 100 can include an apparatus 110 and a scene 120. The apparatus 110 can be a wireless terminal, a portable wireless communication device, a smartphone, a cellular telephone, a flip phone, a personal digital assistant, a device having a subscriber identity module, a personal computer, a selective call receiver, a tablet computer, a laptop computer, a webcam, a DSLR camera, a compact camera, or any other device that is capable of capturing an image of a scene.

In operation, first, second, and third images of the scene 120 can be captured, such as by using sensors (not shown) on the apparatus 110 that face in the same direction 130. The first image can include first image coordinates. The first, second, and third images can be received in the apparatus 110 from the sensors. An x-axis depth map of the first image coordinates can be generated based on the first and second images. A y-axis depth map of the first image coordinates can be generated based on the first and third images. The y-axis can be perpendicular to the x-axis. Edge detection can be performed on the first image to detect edges in the first image. A confidence score map can be generated for each depth map. A higher confidence score on the confidence score map of the x-axis depth map can be set for a pixel on an edge at an angle closer to the y-axis than the x-axis for the pixel on the x-axis depth map. A lower confidence score on the confidence score map of the y-axis depth map can be set for a corresponding pixel on the y-axis depth map. A depth value of a pixel on a fusion depth map can be selected based on the confidence score maps and the depth maps.

For example, two cameras mounted horizontally can provide a depth map using horizontal parallax, and two cameras mounted vertically can provide a depth map using vertical parallax. Depth accuracy of vertical edges in a scene can be higher on the horizontal-parallax depth map and depth accuracy of horizontal edges in the scene is higher on the vertical-parallax depth map. At least two depth maps, such as one horizontal parallax depth map and one vertical parallax depth map can be merged to generate a fusion depth map with high accuracy.

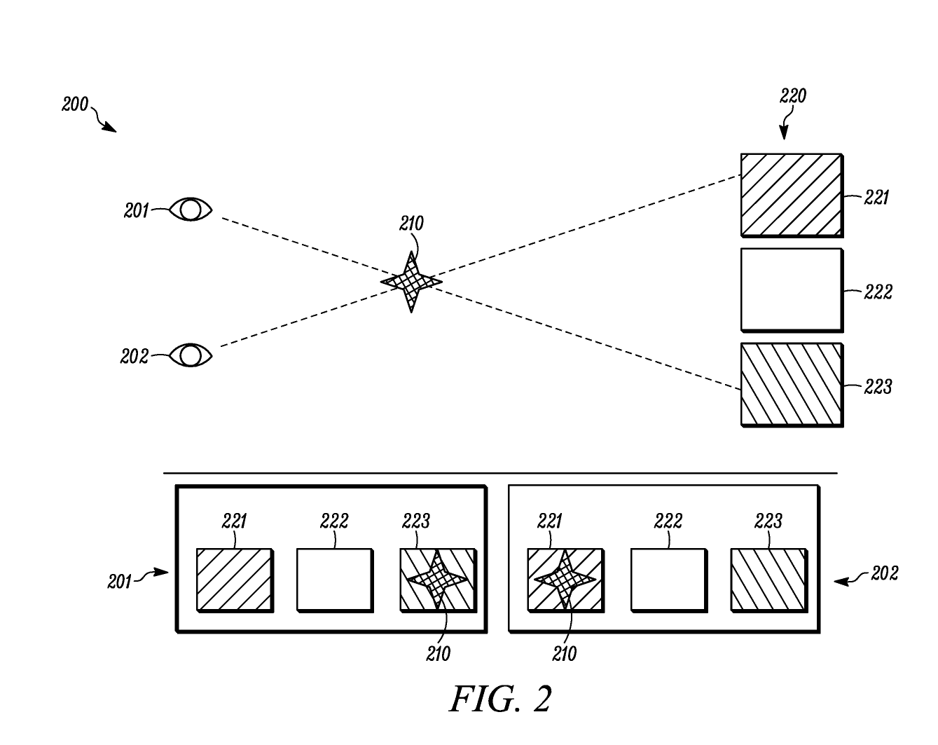

FIG. 2 is an example illustration 200 of parallax of an object according to a possible embodiment. The illustration 200 shows two viewpoints 201 and 202, an object 210, a background 220 including a first background object 221, a second background object 222, and a third background object 223. The object 210 is seen through the first viewpoint 201 against the third background object 223 and the object 210 is seen through the second viewpoint 202 against the first background object 221 due to perspective shift where the object 210 appears to have moved from the third background object 223 to the first background object 221 between the different viewpoints 201 and 202. A depth map can be derived from a disparity map, if intrinsic and extrinsic calibration parameters are known for two cameras, each at one of the viewpoints 201 and 202. A disparity map can be generated using a parallax detection algorithm to find pixel correspondence on a pair of images, acquired by the two cameras.

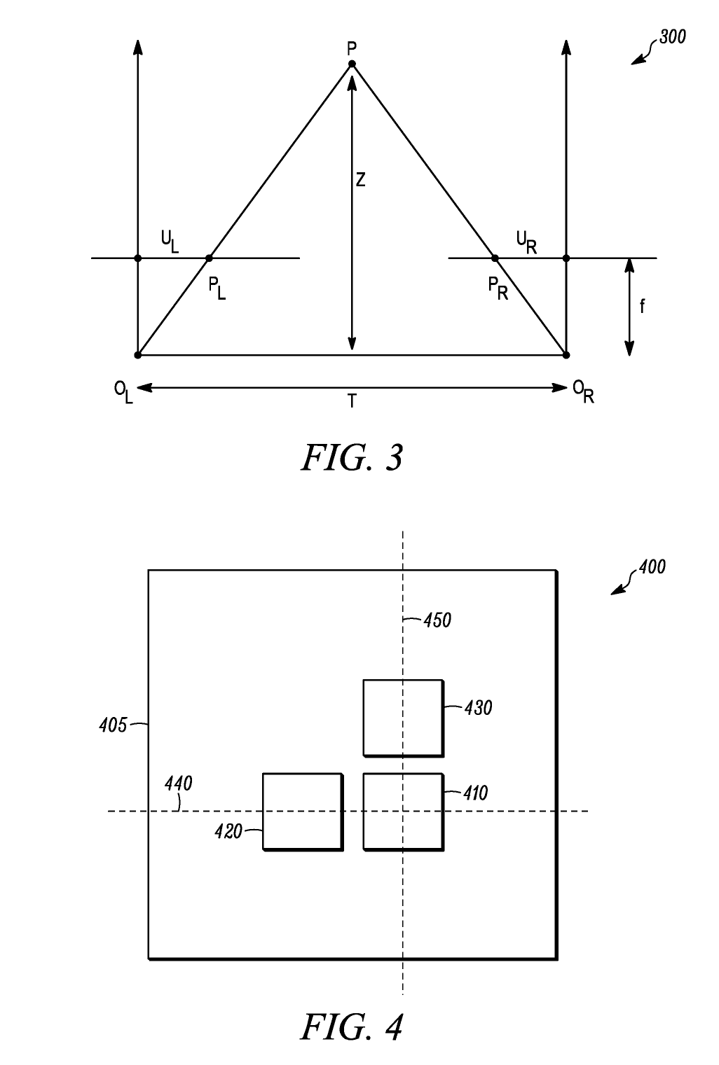

FIG. 3 is an example illustration of a triangulation relationship 300 according to a possible embodiment. The triangulation relationship 300 can include optical centers of two cameras O_{R} and O_{L}, respectively, with the same focal length f spaced a distance T apart. A 3D point P can be located a distance Z from a center between the two cameras O_{L} and O_{R}. An image P_{R} of the 3D point P can have coordinates (u_{R}, v_{R}) with respect to the image center of a right image of the right camera O_{R}. An image PL of the 3D point P can have coordinates (u_{L}, v_{L}) with respect to the image center of a left image of the left camera O_{L}. If two optical axes of the two cameras O_{L} and O_{R} are parallel to each other, depth Z can be calculated per pixel of an image by using the triangulation relationship 300 and the formula:

$$Z - \frac{f T}{\vert {u}_{R} - {u}_{L} \vert}$$

If two optical axes of two cameras are not parallel to each other, then a more complicated formula can be used to derive the depth per pixel.

FIG. 4 is an example illustration 400 of a device 405 including three cameras 410, 420, and 430 according to a possible embodiment. The three cameras 410, 420, and 430 can also be considered to be sensors, as they include sensors among other elements, such as optics and filters. The first camera 410 can face in a first direction, such as out of the illustration 400. The second camera 420 can face in the first direction and can be offset from the first camera 410 in an x-axis 440 direction orthogonal to the first direction. The third camera 430 can face in the first direction and can be offset from the first camera 410 in a y-axis 450 direction orthogonal to the first direction and the x-axis 440 direction.

In operation according to a possible embodiment, a center camera, such as the first camera 410, can be selected as a reference camera. A first depth map, such as a horizontal parallax depth map, can be generated from a first image from the first camera 410 and a second image from the second camera 420 based on the image coordinates of the first camera 410. A second depth map, such as a vertical parallax depth map, can be generated from the first image from the first camera 410 and a third image from the third camera 430 based on the image coordinates of the first camera 410. This can ensure that the two depth maps share the same reference pixel coordinates.

An edge detection algorithm can be applied on the first image of the first camera, the reference camera. For each edge pixel on the image of the reference camera, if a given pixel is located on a vertical edge, such as an edge more vertical than horizontal, then a confidence score can be higher at this pixel of the horizontal-parallax depth map, but the confidence score can be lower at this pixel of the vertical-parallax depth map. One score map can be generated for each depth map. On the horizontal-parallax depth map, the confidence score can decrease when the orientation of an edge is further away from the vertical axis. On the vertical-parallax depth map, the confidence score can decrease when the orientation of an edge is further away from the horizontal axis. For an edge at 45 degrees, the confidence score can be the same on both the horizontal-parallax depth map and the vertical-parallax depth map.

For each depth map, the confidence score of pixels between two edges can be interpolated by using the following logic: if two edges are part of a closed contour, such as an object in a scene, then the confidence score of pixels inside the closed contour can be interpolated from the confidence score of two edge pixels per row. The confidence score of pixels outside a closed counter can be set to a low score, because the parallax cannot accurately determine depth of those pixels outside a closed contour. Typically, the true depth of those pixels may be greater than the maximum detectable depth in a camera system, as they may correspond to very distant objects. Eventually, each pixel can have a confidence score per depth map. One special scenario can occur when pixels within occlusion areas may have 0 as the confidence score, because the parallax detection algorithm fails on those pixels. Occlusion can mean that a scene object appears on one image, but does not appear on the other image in a dual camera system. Therefore, a pixel correspondence cannot be found between two images for this scene object. For example, when a person puts a bottle very close to their two eyes, then the left eye sees features of the bottle that the right eye cannot see. This can be considered occlusion. As a further example, occlusion can occur when an object is close enough to the sensors that one sensor cannot sense points on the object that the other sensor can sense.

For each pixel, if the confidence score of the horizontal-parallax depth map is higher than the confidence score of the vertical-parallax depth map, then the depth value of the horizontal-parallax depth map can be set as the pixel value of the fusion depth map. Some exceptions can be handled in different ways. According to a possible exception if two scores are the same for a given pixel, the depth values from each depth map can be averaged. According to another possible exception, if two scores for a given pixel are very close, such as within a threshold distance, the two depth map values can be averaged. According to a possible implementation, this threshold can be defined by the precision of depth detection at a depth value. According to another possible exception for a pixel located in a corner or in the intersection of two edges, a special confidence score can be set. For example, the same confidence score can be set on both score maps, and the fusion depth map can be the average of the two corresponding depths. According to another scenario, if one edge closer to x-axis or y-axis, and the other edge is not, then the depth can be selected from the higher score.

According to a possible coordinate system of the present disclosure, an x-axis and y-axis can correspond to a device, such as a smartphone. When a user holds the device from 0 to 45 degrees, the x-axis of the device can correspond to a horizontal parallax. When the user holds the device from 45 to 90 degrees, the x-axis of the device can correspond to a vertical parallax.

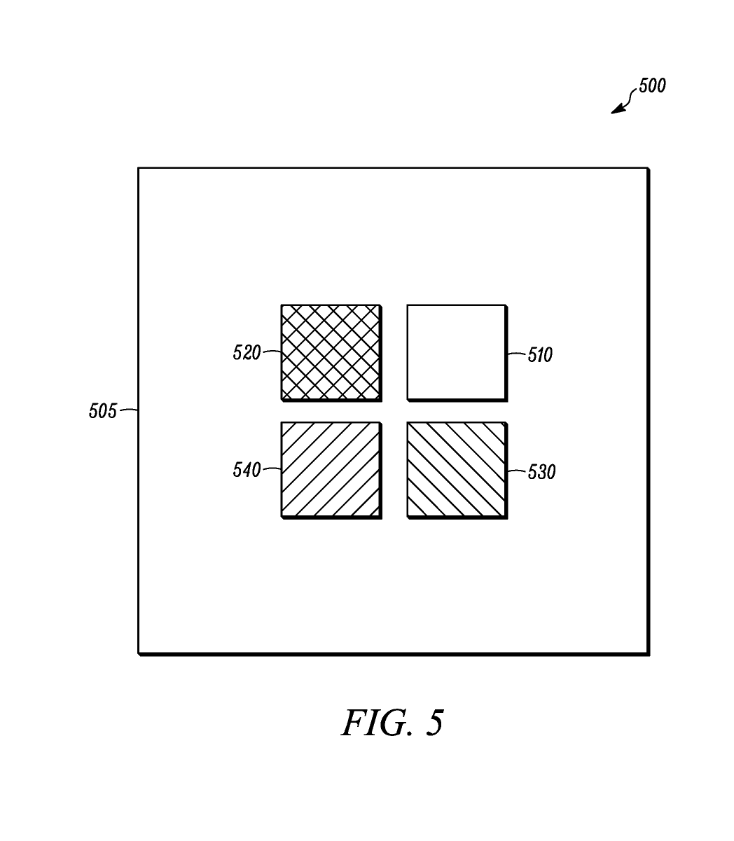

FIG. 5 is an example illustration 500 of a device 505 including four cameras 510, 520, 530, and 540, that can also be considered to be sensors, according to a possible embodiment for merging three depth maps for four cameras. While the cameras 510, 520, 530, and 540 can be cameras in any system, according to a possible embodiment, they can be a 2×2 camera array. For example, the camera 510 can be a camera with a clear filter, the camera 520 can be a camera with a blue filter, the camera 530 can be a camera with a green filter, and the camera 540 can be a camera with a red filter. The cameras 510, 520, and 530 of the device 500 can operate similarly to the cameras 410, 420, and 430, respectively, of the device 400 for the generation of the first two depth maps. Coordinates of the two depth maps can match image coordinates of the clear camera 510. The image from the red camera 540 and the image from the green camera 530 can generate an additional depth map. The coordinates of the additional depth map can match the image coordinates from the green camera 530. By applying an edge detection algorithm on the image of green camera, the confidence score can be determined on this depth map. By using a parallax detection algorithm between the image from the clear camera 510 and the image from the green camera 530, the pixel coordinate of the additional depth map and its confidence score map can be converted to the image coordinate of the clear camera 510. Then, a fusion depth map can be generated by comparing the confidence scores among all three depth maps per pixel.

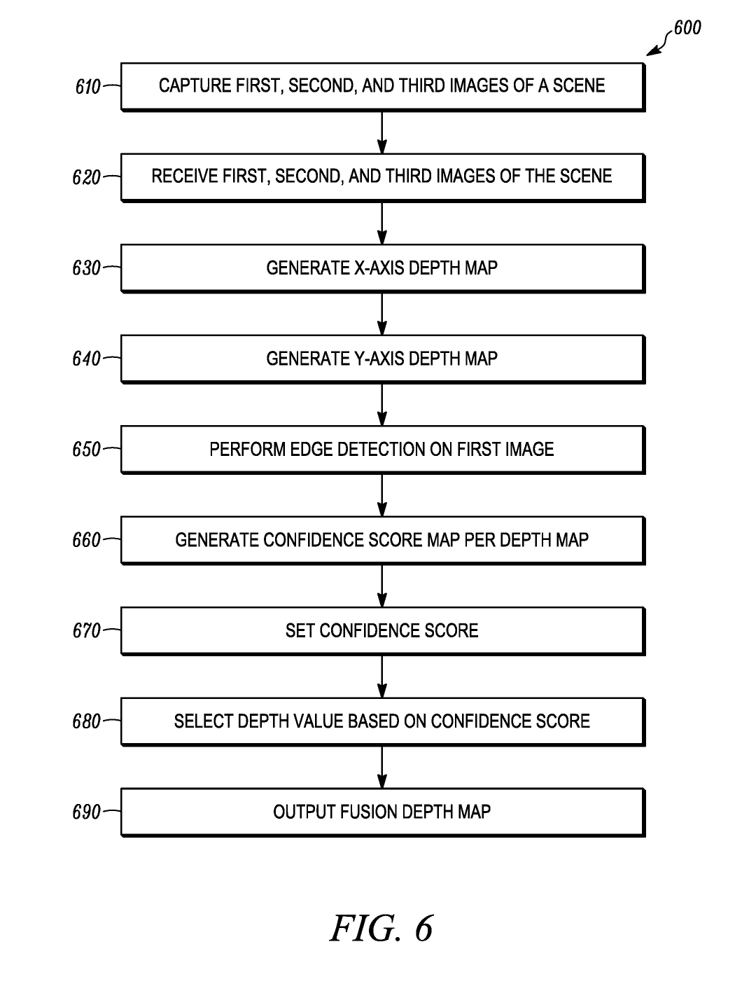

FIG. 6 is an example flowchart 600 illustrating the operation of a device, such as the apparatus 110, according to a possible embodiment. At 610, first, second, and third images of a scene can be captured. The first image can be captured using a reference first sensor, such as a sensor of a camera, on a device. The first sensor can face in a first direction. The second image can be captured using a second sensor, such as a sensor of a camera, on the device. The second sensor can face in the first direction and can be offset from the first sensor in an x-axis direction orthogonal to the first direction. The third image can be captured using a third sensor, such as a sensor of a camera, on the device. The third sensor can face in the first direction and can be offset from the first sensor in a y-axis direction orthogonal to the first direction and the x-axis direction. Additional sensors can be used, such as four or more, a 2×2 array including four sensors, a 5×5 array camera having 25 sensors, a 4×5 array including 20 sensors, or any other number or sensors, and additional depth map information from additional sensors can be propagated back to a reference coordinate system. Per the theory of parallax, every two viewpoints can generate a depth map.

The x-axis and y-axis can be local to a device. For example, the x-axis can correspond to a horizontal axis of an image captured by a sensor of the device and the y-axis can correspond to a vertical axis of an image captured by the sensor of the device. Furthermore, the x-axis and y-axis can change depending on the device orientation, such as depending on whether a device is capturing an image in landscape mode or portrait mode. For example, the x-axis can correspond to a horizontal parallax up when device orientation detection determines the device is oriented up to 45 degrees from a horizontal landscape mode. Example elements that can determine device orientation can include a gyroscope, an accelerometer, an inclinometer, position detection sensors, and other elements that can determine device orientation. Additionally, the x-axis can correspond to an axis between a first sensor and a second sensor and the y-axis can correspond to an axis between the first sensor and a third sensor where the y-axis is perpendicular to the x-axis. At 620, the first, second, and third images of a scene can be received from the sensors, such as received at a controller, such as an image signal processor. The first image can include first image coordinates.

At 630, an x-axis depth map of the first image coordinates can be generated based on the first and second images. A depth map can be defined as an image of values, integer or real, that represent distance from a viewpoint. Two common definitions can be depth along the optical axis, such as a z-axis, and depth along the optic ray passing through each pixel. Depth can be considered to be along an axis in the direction that a sensor is facing. Triangulation can be used to determine a depth map using parallax, where parallax is a displacement or difference in the apparent position of an object viewed along two different lines of sight, and is measured by the angle or semi-angle of inclination between those two lines. A depth map can be derived from a disparity map, if intrinsic and extrinsic calibration parameters are known for every two cameras. A disparity map can be generated using a parallax detection algorithm to find pixel correspondence on a pair of images, acquired by two cameras. For example, the farther an object is, the smaller the disparity will be between two corresponding points. Similarly, the closer an object is, the larger the disparity will be between two corresponding points. Then, per pixel, depth can be calculated by using a triangulation relationship and a formula, such as when the two optical axes of two cameras are parallel to each other. If two optical axes of two cameras are not parallel to each other, then a more complicated formula can be used to derive the depth per pixel. When the sensors and lenses of two cameras are different, a depth map can be generated using a disparity map before the merge process of two depth maps. At 640, a y-axis depth map of the first image coordinates can be generated based on the first and third images. The y-axis can be perpendicular to the x-axis.

At 650, edge detection can be performed on the first image to detect edges in the first image. Edge detection can include detecting edges of objects in the first image. At 660, a confidence score map can be generated for each depth map.

At 670, a higher confidence score on the confidence score map of the x-axis depth map can be set for a pixel on an edge at an angle closer to the y-axis than the x-axis for the pixel on the x-axis depth map. A lower confidence score on the confidence score map of the y-axis depth map can be set for a corresponding pixel on the y-axis depth map. For example, the highest confidence score can be a value of 100 and the lowest confidence score can be a value of zero. The confidence score can be any other values depending desired data precision and numerical operations of a device. Setting the confidence scores can include setting a higher confidence score for a pixel on an edge at an angle closer to the x-axis than the y-axis for the pixel on the confidence score map of the y-axis depth map and a lower confidence score of a corresponding pixel on the confidence score map of the x-axis depth map. The confidence score of the pixel on the confidence score map of the x-axis depth map can decrease as the edge moves away from a line orthogonal to the x-axis and the confidence score of the corresponding pixel on the confidence score map of the y-axis depth map can increase as the edge moves away from a line orthogonal to the x-axis. For example, a spectrum of confidence scores can be assigned to pixels based on the angle of the edge relative to the x-axis and y-axis. Different confidence scores can be used for different edge orientations, such as edges at different angles. The closer an edge is to the y-axis, the higher the confidence score can be on the confidence score map of the horizontal parallax, such as the x-axis depth map, and the close an edge is to the x-axis, the higher the confidence score can be on the confidence score map of the vertical parallax, such as the y-axis depth map. When setting the confidence scores, a corner pixel may need special treatment, such as where two edges intersect. For example, when a pixel is at the intersection of two edges, the confidence score can be set as the same score for the pixel on the confidence score maps for both depth maps. Also, if one edge is closer to one axis than the other is to another axis, the pixel corresponding to the edge closer to a given axis can be given the higher confidence score for the confidence score map of the corresponding depth map. Setting the confidence scores can also include setting confidence scores of pixels on the confidence score map of the x-axis depth map in between two edges at an angle closer to the y-axis by interpolating confidence scores between the two edges for the pixels on the confidence score map of the x-axis depth map.

At 680, a depth value of a pixel on a fusion depth map can be selected based on the confidence score maps and the depth maps. Selecting the depth value can include determining the depth value of a pixel on the fusion depth map based on the confidence score maps using a decision rule. The decision rule can include selecting the depth value of a pixel on the fusion depth map as the depth value of the pixel with the higher confidence score between the confidence score of the pixel on the confidence score map of the x-axis depth map and the confidence score of the corresponding pixel on the confidence score map of the y-axis depth map. Selecting the depth value can also include averaging the depth values between corresponding pixels on the x-axis depth map and y-axis depth map when the confidence score of each corresponding pixel on the confidence scores maps of two depth maps is within a threshold difference from each other. For example, the depth values can be averaged when the difference between confidence scores is within a value of zero, five, or ten on a 0-100 scale or any other threshold difference useful for determining that the confidence scores are the same or close to each other. Different threshold values can also be used depending on the scale used for the confidence scores. The decision rule can also include selecting the depth value for a pixel on a fusion depth map based on a depth value of the pixel on the confidence score map of the x-axis depth map when the confidence score of the corresponding pixel on the confidence score map of the x-axis depth map is higher than the confidence score of the corresponding pixel on the confidence score map of the y-axis depth map. The final fusion depth map can be derived from a final fusion disparity map when the offsets of every two cameras are the same, and the sensors and corresponding lenses are substantially similar, such as having similar pixel resolution and similar focal lengths. The final fusion disparity map can be generated by merging two disparity maps in the same fashion as it is done in merging two depth maps.

At 690, the fusion depth map can be output. For example, the fusion depth map can be output to memory, to a transceiver, to a file, or otherwise output. The fusion depth map can be output by being embedded in an image file, can be output along with an image file, can be embedded in a jpeg file, can be embedded in an image container, and/or can be otherwise output.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

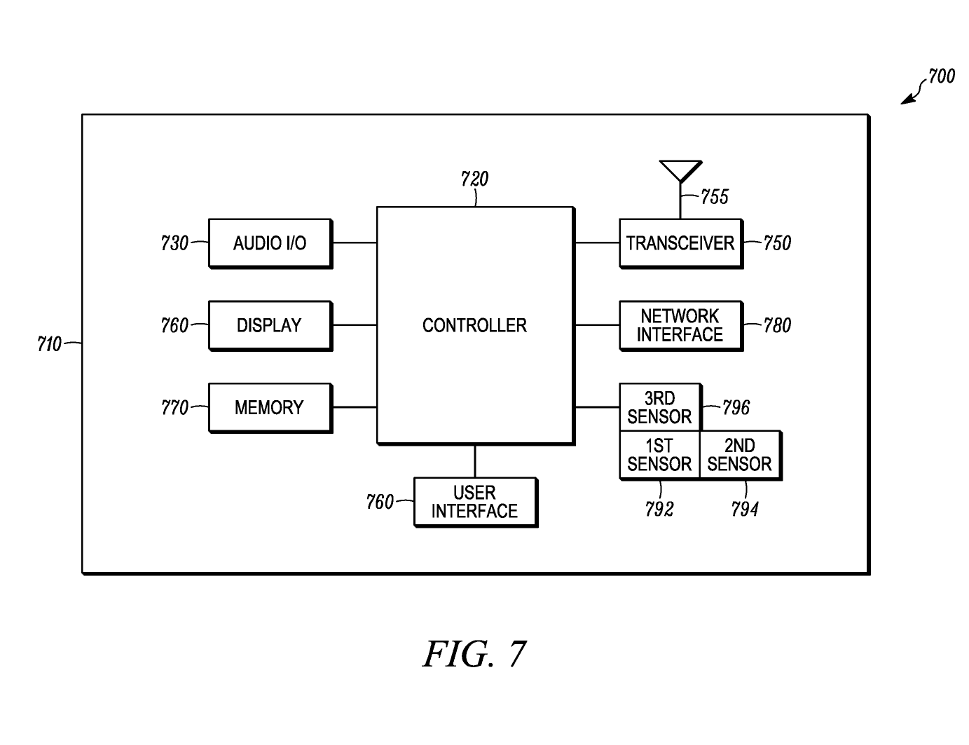

FIG. 7 is an example block diagram of an apparatus 700, such as the apparatus 110, according to a possible embodiment. The apparatus 700 can include a housing 710, a controller 720 within the housing 710, audio input and output circuitry 730 coupled to the controller 720, a display 740 coupled to the controller 720, a transceiver 750 coupled to the controller 720, an antenna 755 coupled to the transceiver 750, a user interface 760 coupled to the controller 720, a memory 770 coupled to the controller 720, and a network interface 780 coupled to the controller 720. The apparatus 700 can also include a first sensor 792, a second sensor 794, and a third sensor 796. The apparatus 700 can perform the methods described in all the embodiments.

The sensors 792, 794, and 796 can also be considered cameras. The first sensor 792 can be considered a reference sensor in that it can be the sensor that is common between the two other sensors 794 and 796. The first sensor 792 can face in a first direction. The second sensor 794 can face in the first direction and can be offset from the first sensor 792 in an x-axis direction orthogonal to the first direction. The third sensor 796 can face in the first direction and can be offset from the first sensor 792 in a y-axis direction orthogonal to the first direction and the x-axis direction.

The display 740 can be a viewfinder, a liquid crystal display (LCD), a light emitting diode (LED) display, a plasma display, a projection display, a touch screen, or any other device that displays information. The transceiver 750 can include a transmitter and/or a receiver. The audio input and output circuitry 730 can include a microphone, a speaker, a transducer, or any other audio input and output circuitry. The user interface 760 can include a keypad, a keyboard, buttons, a touch pad, a joystick, a touch screen display, another additional display, or any other device useful for providing an interface between a user and an electronic device. The network interface 780 can be a Universal Serial Bus (USB) port, an Ethernet port, an infrared transmitter/receiver, an IEEE 1394 port, a Wireless Local Area Network (WLAN) transceiver, or any other interface that can connect an apparatus to a network, device, or computer and that can transmit and receive data communication signals. The memory 770 can include a random access memory, a read only memory, an optical memory, a flash memory, a removable memory, a hard drive, a cache, or any other memory that can be coupled to an apparatus including a camera.

The apparatus 700 or the controller 720 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 770 or elsewhere on the apparatus 700. The apparatus 700 or the controller 720 may also use hardware to implement disclosed operations. For example, the controller 720 may be any programmable processor. Disclosed embodiments may also be implemented on a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 720 may be any controller or processor device or devices capable of operating an apparatus including a camera and implementing the disclosed embodiments.

In operation, the first sensor 792 can capture a first image of a scene. The second sensor 794 can capture a second image of the scene. The third sensor 796 can capture a third image of the scene. The controller 720 can generate an x-axis depth map of the first image coordinates, based on the first and second images. The controller 720 can generate a y-axis depth map of the first image coordinates, based on the first and third images, where the y-axis is perpendicular to the x-axis. The controller 720 can perform edge detection on the first image to detect edges in the first image. Edge detection can be performed by detecting edges of objects in the first image. The controller 720 can generate a confidence score map for each depth map.

The controller 720 can set a higher confidence score on the confidence score map of the x-axis depth map for a pixel on an edge at an angle closer to the y-axis than the x-axis for the pixel on the x-axis depth map. The controller 720 can set a lower confidence score on the confidence score map of the y-axis depth map of a corresponding pixel on the y-axis depth map. According to a related possible embodiment, the controller 720 can set a higher confidence score for a pixel on an edge at an angle closer to the x-axis than the y-axis for the pixel on the confidence score map of the y-axis depth map and a lower confidence score of a corresponding pixel on the confidence score map of the x-axis depth map. According to another related possible embodiment, the confidence score of the pixel on the confidence score map of the x-axis depth map can decrease as the edge moves away from a line orthogonal to the x-axis and the confidence score of the corresponding pixel on the confidence score map of the y-axis depth map can increase as the edge moves away from a line orthogonal to the x-axis. According to another related possible embodiment, the controller 720 can set confidence scores of pixels on the confidence score map of the x-axis depth map in between two edges at an angle closer to the y-axis by interpolating confidence scores between the two edges for the pixels on the confidence score map of the x-axis depth map.

The controller 720 can select a depth value of a pixel on a fusion depth map based on the confidence score maps and the depth maps. The depth value can be selected by determining the depth value of a pixel on the fusion depth map based on the confidence score maps using a decision rule. The decision rule can select the depth value of a pixel on the fusion depth map as the depth value of the pixel with the higher confidence score between the confidence score of the pixel on the confidence score map of the x-axis depth map and the confidence score of the corresponding pixel on the confidence score map of the y-axis depth map. The controller 720 can average the depth values between corresponding pixels on the x-axis depth map and y-axis depth map when the confidence score of each corresponding pixel on the confidence scores maps of two depth maps is within a threshold difference from each other. The decision rule can also select the depth value for a pixel on a fusion depth map based on a depth value of the pixel on the confidence score map of the x-axis depth map when the confidence score of the corresponding pixel on the confidence score map of the x-axis depth map is higher than the confidence score of the corresponding pixel on the confidence score map of the y-axis depth map.

The controller 720 can output the fusion depth map, such as to memory 770, to the network interface 780, to the transceiver 750, to a file, or otherwise output the fusion depth map. The fusion depth map can be output by being embedded in an image file, can be output along with an image file, can be embedded in a jpeg file, can be embedded in an image container, and/or can be otherwise output.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of” or “at least one selected from the group of” followed by a list is defined to mean one, some, or all, but not necessarily all of, the elements in the list. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

We claim:

1. A method comprising:
receiving a first image of a scene, the first image including first image coordinates;
receiving a second image of the scene;
receiving a third image of the scene;
generating an x-axis depth map of the first image coordinates based on the first and second images;
generating a y-axis depth map of the first image coordinates based on the first and third images, where the y-axis is perpendicular to the x-axis;
performing edge detection on the first image to detect edges in the first image;
generating a confidence score map for each depth map;
setting a higher confidence score on the confidence score map of the x-axis depth map for a pixel on an edge at an angle closer to the y-axis than the x-axis for the pixel on the x-axis depth map and a lower confidence score on the confidence score map of the y-axis depth map for a corresponding pixel on the y-axis depth map; and
selecting a depth value of a pixel on a fusion depth map based on the confidence score maps and the depth maps.

2. The method according to claim 1, wherein selecting the depth value comprises determining the depth value of a pixel on the fusion depth map based on the confidence score maps using a decision rule.

3. The method according to claim 2, wherein the decision rule comprises selecting the depth value of a pixel on the fusion depth map as the depth value of the pixel with the higher confidence score between the confidence score of the pixel on the confidence score map of the x-axis depth map and the confidence score of the corresponding pixel on the confidence score map of the y-axis depth map.

4. The method according to claim 3, wherein selecting comprises averaging the depth values between corresponding pixels on the x-axis depth map and y-axis depth map when the confidence score of each corresponding pixel on the confidence scores maps of two depth maps is within a threshold difference from each other.

5. The method according to claim 2, wherein the decision rule comprises selecting the depth value for a pixel on a fusion depth map based on a depth value of the pixel on the confidence score map of the x-axis depth map when the confidence score of the corresponding pixel on the confidence score map of the x-axis depth map is higher than the confidence score of the corresponding pixel on the confidence score map of the y-axis depth map.

6. The method according to claim 1, wherein setting comprises setting a higher confidence score for a pixel on an edge at an angle closer to the x-axis than the y-axis for the pixel on the confidence score map of the y-axis depth map and a lower confidence score of a corresponding pixel on the confidence score map of the x-axis depth map.

7. The method according to claim 1, wherein the confidence score of the pixel on the confidence score map of the x-axis depth map decreases as the edge moves away from a line orthogonal to the x-axis and the confidence score of the corresponding pixel on the confidence score map of the y-axis depth map increases as the edge moves away from a line orthogonal to the x-axis.

8. The method according to claim 1, wherein performing edge detection comprises detecting edges of objects in the first image.

9. The method according to claim 1, further comprising outputting the fusion depth map.

10. The method according to claim 1, wherein setting includes setting confidence scores of pixels on the confidence score map of the x-axis depth map in between two edges at an angle closer to the y-axis by interpolating confidence scores between the two edges for the pixels on the confidence score map of the x-axis depth map.

11. The method according to claim 1, further comprising:
capturing the first image of a scene using a first sensor on a device, the first sensor facing in a first direction;
capturing the second image of the scene using a second sensor on the device, the second sensor facing in the first direction, the second sensor offset from the first sensor in an x-axis direction orthogonal to the first direction; and
capturing the third image of the scene using a third sensor on the device, the third sensor facing in the first direction, the third sensor offset from the first sensor in a y-axis direction orthogonal to the first direction and the x-axis direction.

12. An apparatus comprising:
a first sensor to capture a first image of a scene, the first sensor facing in a first direction, the first image including first image coordinates;
a second sensor to capture a second image of the scene the second sensor facing in the first direction and, the second sensor offset from the first sensor in an x-axis direction orthogonal to the first direction;
a third sensor configured to capture a third image of the scene, the third sensor facing in the first direction, and the third sensor offset from the first sensor in a y-axis direction orthogonal to the first direction and the x-axis direction;
a controller to
generate an x-axis depth map of the first image coordinates, based on the first and second images,
generate a y-axis depth map of the first image coordinates, based on the first and third images, where the y-axis is perpendicular to the x-axis,
perform edge detection on the first image to detect edges in the first image,
generate a confidence score map for each depth map,
set a higher confidence score on the confidence score map of the x-axis depth map for a pixel on an edge at an angle closer to the y-axis than the x-axis for the pixel on the x-axis depth map and a lower confidence score on the confidence score map of the y-axis depth map of a corresponding pixel on the y-axis depth map, and
select a depth value of a pixel on a fusion depth map based on the confidence score maps and the depth maps.

13. The apparatus according to claim 12, wherein the controller selects the depth value by determining the depth value of a pixel on the fusion depth map based on the confidence score maps using a decision rule.

14. The apparatus according to claim 13, wherein the decision rule selects the depth value of a pixel on the fusion depth map as the depth value of the pixel with the higher confidence score between the confidence score of the pixel on the confidence score map of the x-axis depth map and the confidence score of the corresponding pixel on the confidence score map of the y-axis depth map.

15. The apparatus according to claim 14, wherein the controller averages the depth values between corresponding pixels on the x-axis depth map and y-axis depth map when the confidence score of each corresponding pixel on the confidence scores maps of two depth maps is within a threshold difference from each other.

16. The apparatus according to claim 13, wherein the decision rule selects the depth value for a pixel on a fusion depth map based on a depth value of the pixel on the confidence score map of the x-axis depth map when the confidence score of the corresponding pixel on the confidence score map of the x-axis depth map is higher than the confidence score of the corresponding pixel on the confidence score map of the y-axis depth map.

17. The apparatus according to claim 12, wherein the controller sets a higher confidence score for a pixel on an edge at an angle closer to the x-axis than the y-axis for the pixel on the confidence score map of the y-axis depth map and a lower confidence score of a corresponding pixel on the confidence score map of the x-axis depth map.

18. The apparatus according to claim 12, wherein the confidence score of the pixel on the confidence score map of the x-axis depth map decreases as the edge moves away from a line orthogonal to the x-axis and the confidence score of the corresponding pixel on the confidence score map of the y-axis depth map increases as the edge moves away from a line orthogonal to the x-axis.

19. The apparatus according to claim 12, further comprising an output configured to output the fusion depth map.

20. The apparatus according to claim 12, wherein the controller sets confidence scores of pixels on the confidence score map of the x-axis depth map in between two edges at an angle closer to the y-axis by interpolating confidence scores between the two edges for the pixels on the confidence score map of the x-axis depth map.
